(19) United States
(12) Patent Application Publication
(10) Pub. No.: US 2011/0222991 A1
(43) Pub. Date: Sep. 15, 2011

(54) TRANSVERSE MOVING APPARATUS FOR PUNCHING AND BINDING MACHINES

(76) Inventor: Li-Ming CHENG, Kaohsiung City (TW)

(21) Appl. No.: 12/719,868

(22) Filed: Mar. 9, 2010

(51) Int. Cl. B42B 9/00

(52) U.S. Cl. 412/16

(57) ABSTRACT

A transverse moving apparatus for a punching and binding machine to bind papers through plastic combs includes axles at two sides of a crook arm to drive sloped surfaces formed at two lateral sides of a claw module. Through moving on the sloped surfaces, claws of the claw module can be driven axially to engage with the plastic combs and moved in the circumferential direction to unwind the plastic combs to punch and bind papers. Once the papers are positioned and bound, the claws return in the opposite direction to their original positions.

### FIELD OF THE INVENTION

The present invention relates to a transverse moving apparatus for punching and binding machines and particularly to a simplified transverse moving apparatus consisting of fewer elements to bind punched papers through plastic combs.

### BACKGROUND OF THE INVENTION

A conventional binding machine 10 such as U.S. Pat. No. 5,615,986 (referring to FIG. 1) has a pinion 11 with teeth 111 on the circumference, a plate 12 with a plurality of apertures 121 formed at one edge, and a binding module 13 movably coupled with the plate 12 that has claws 131 formed thereon. The teeth 111 are engaged with the apertures 121. The pinion 11 is turnable to drive the claws 131 reciprocally through the plate 12 to latch on punched papers 15 to become a binding volume to facilitate filing and leafing. The apertures of the papers 15 are formed through punch cutters (not shown in the drawing) by driving a pressing bar downwards on the binding machine 10. The claws 131 are movable reciprocally in the front and rear direction against the plate 12 through turning of the pinion 11 to unwind plastic comb 14 in a linear manner to hold and bind the punched papers 15 (referring to FIG. 2). The papers 15 are loaded in the punch and binding module 13 in different directions to be bound. Moreover, the teeth 111 first drive the plate 12, then drive the claws 131 to unwind the plastic comb 14. Such a design requires a greater movement range, and a complex structure with numerous elements is needed. As a result, the binding machine 10 is bulky and the cost is higher.

### SUMMARY OF THE INVENTION

The present invention aims to improve the design of the conventional punching and binding machine that has to provide a greater planar movement range for the claws and is bulky and occupies a larger area by providing a transverse moving apparatus for punching and binding machines that includes two axles at two sides of a crook arm to drive sloped surfaces formed on lateral sides of a claw module. Such a design can drive claws of the claw module to move axially to engage with plastic combs and move in the circumferential direction to unwind the plastic combs to facilitate positioning and binding of punched papers.

To achieve the foregoing object the transverse moving apparatus according to the present invention is structured to bind papers through the plastic combs. The transverse moving apparatus includes two axles coupling with a stem of the crook arm, a claw module and an aperture holding bar. The axles are movably coupled on two sides of the crook arm. The claw module is pivotally coupled with the two axles and has at least one recess on each of two sides to allow struts of the two axles to move and turn therein. The aperture holding bar is located at a front end of the claw module. The crook arm has coupling portions at two sides and a stem bridging the two coupling portions, the coupling portions being movably coupled with the two axles

The transverse apparatus thus formed provides many benefits, notably:

1. It can be used to bind papers through the plastic combs and is simply structured with fewer elements than the conventional binding machine. The axles can be turned through the stem of the crook arm to drive a sloped surface at one side of the claw module so that claws can be moved axially to engage with the plastic combs and move in the circumferential direction to unwind the plastic combs to facilitate positioning and binding of the punched papers. Once the papers are positioned, the claws return to their original positions and the papers can be bound as desired.

2. The present invention provides a simplified structure with fewer elements than the conventional design of the claws, and does not need a greater planar movement space for the claws. Production cost is lower and product is compact and occupies less space.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is a fragmentary perspective view of the binding module of a binding machine of U.S. Pat. No. 5,615,986.

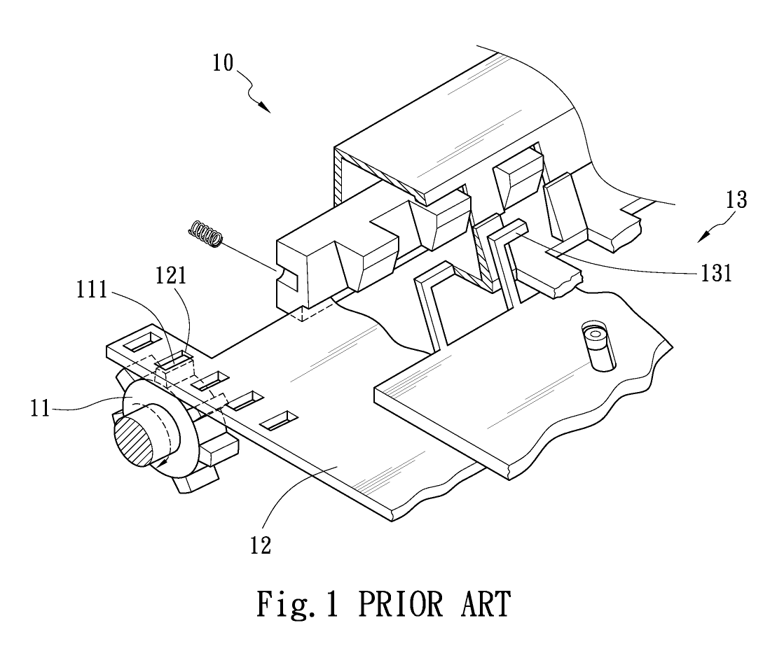

FIG. 2 is a schematic view of the binding module according to FIG. 1 in a condition of unwinding a plastic comb.

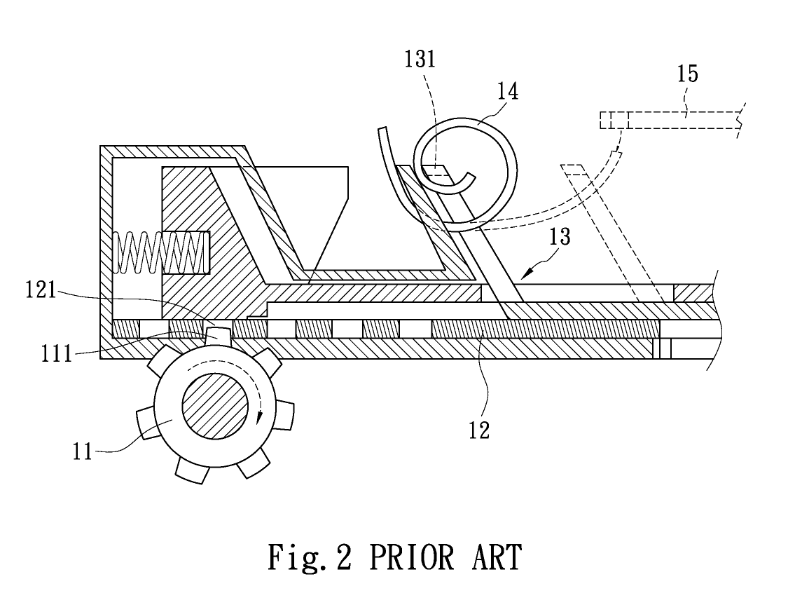

FIG. 3 is a perspective view of the binding machine according to the present invention.

FIG. 4 is an exploded view of the binding machine and the transverse moving apparatus of the present invention.

FIG. 5 is an exploded view of a right side assembly of the transverse moving apparatus of the present invention.

FIG. 6 is an exploded view of a left side assembly of the transverse moving apparatus of the present invention.

FIG. 7 is a schematic rear view of the binding machine of the present invention in punch operation.

FIG. 8 is a perspective view of the binding machine of the present invention in binding operation.

FIG. 9 is a schematic view of the transverse moving apparatus of the present invention in an operating condition.

FIG. 10 is an exploded view of another embodiment of the transverse moving apparatus of the present invention.

FIG. 11 is another exploded view of another embodiment of the transverse moving apparatus of the present invention.

FIG. 12 is a perspective view of another embodiment of the present invention with the transverse moving apparatus adopted for use on another binding machine.

### DETAILED DESCRIPTION OF THE PREFERRED EMBODIMENTS

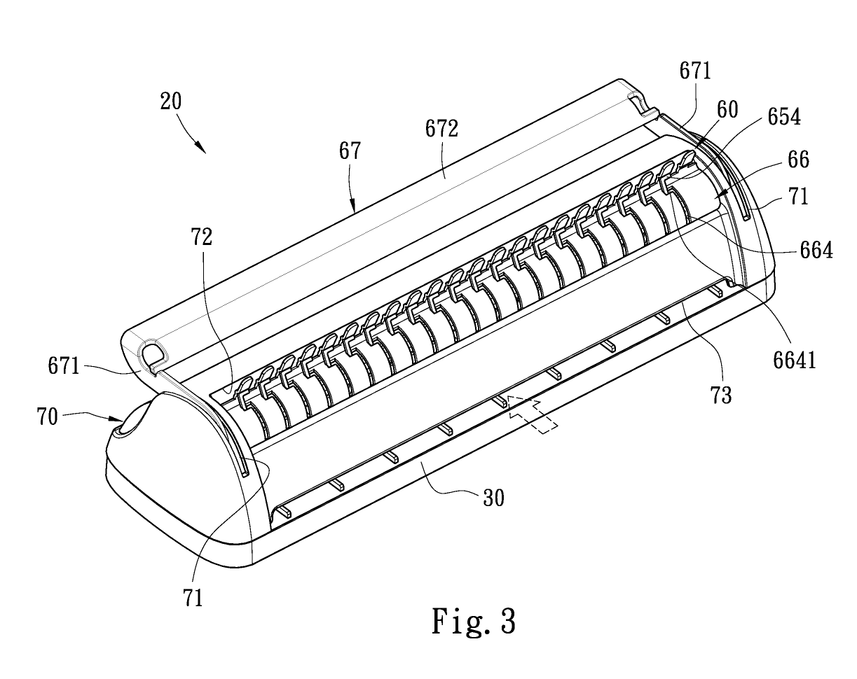

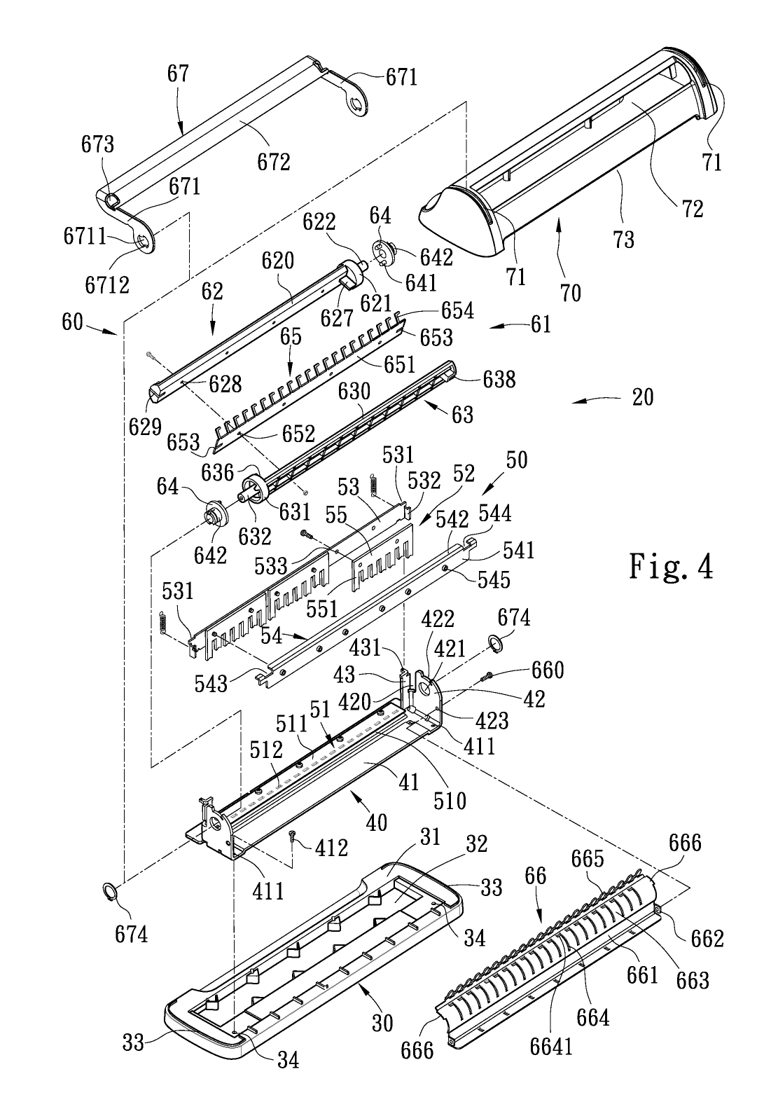

Please referring to FIGS. 3 and 4, the present invention provides a transverse moving apparatus 60 to bind papers with plastic combs and is deployed on a punching and binding machine 20 which is movable axially for punching and binding operation at the same location. The punching and binding machine 20 includes a base 30, a frame 40 located on a platen 31 of the base 30, a punch 50 located above the frame 40 with the transverse moving apparatus 60 located at the front end thereof and an upper cover 70.

The platen 31 of the base 30 has a trough 32 at the top surface close to the rear end to allow a cutter assembly 52 to perform up and down strokes, and jutting edge 33 at two sides of the base 30, and fastening holes 34 near the jutting edges 33 close to the front end to fasten the frame 40.

The frame 40 is fastened to the base 30 close to the front end, and has a base board 41 with two corresponding anchor plates 42 extended from two sides thereof. Each of the anchor plates 42 has a directing strut 43 close to the rear end. The directing strut 43 and the anchor plate 42 are connected at a lower section and formed a gap 420 between them at an upper section. Each of the anchor plates 42 has an axle hole 421 and a latch notch 422 on the upper side, and an aperture 423 at the front end. Each of the directing struts 43 has a first hook 431 at the upper side. The base board 41 has holes 411 at two sides corresponding to the fastening holes 34 of the base 30 to receive fastening elements 412 to form fastening between them.

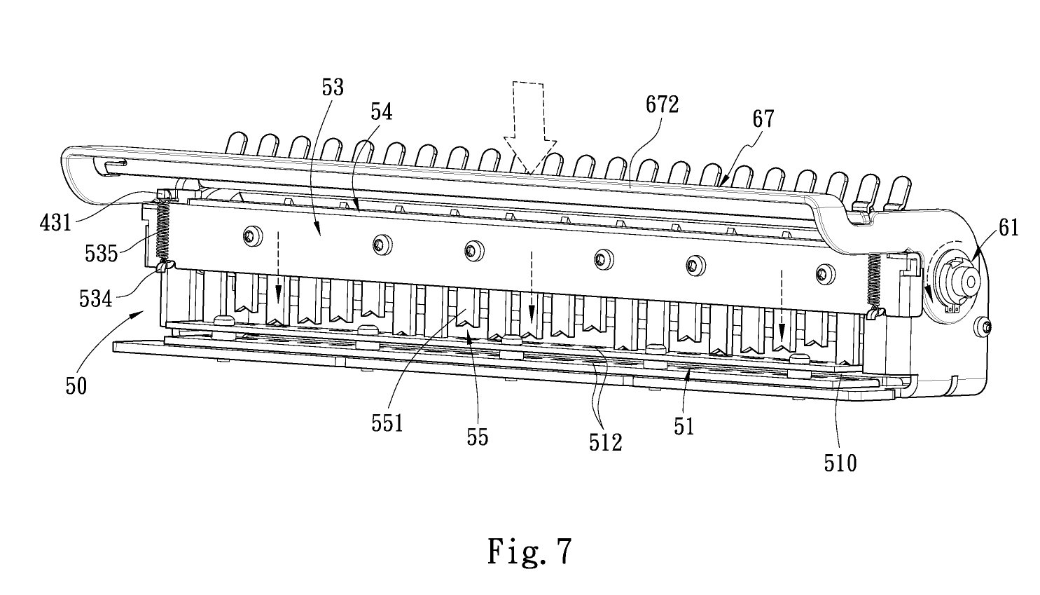

The punch 50 is located above the frame 40, and has a paper holding portion 51 and the cutter assembly 52. The paper holding portion 51 has two corresponding boards 511 to form a paper holding space 510 between them to hold papers. It is fastened to two sides of the base board 41 between the directing struts 43. Each of the two boards 511 has at least one aperture 512 spaced equally or unequally from each other. The cutter assembly 52 includes a first clamp plate 53 and a second clamp plate 54 that are corresponding to the directing struts 43 and movable up and down, and the cutter assembly 52 has at least one cutter set 55 interposed between the first clamp plate 53 and the second clamp plate 54. The first clamp plate 53 has two corresponding top butting ends 531 at two ends and lugs 532 at the front end of two edges thereof and second hooks 534 at the corresponding rear ends. The two second hooks 534 and the first hooks 431 of the two directing struts 43 are bridged by an elastic element 535 (referring to FIG. 7) so that an elastic force is provided by the elastic element 535 to return a crook arm 67 immediately after being pushed downwards. The first clamp plate 53 further has at least one fastening hole 533.

The second clamp plate 54 has an upright plate 541 and an upper flange 542 vertical to the upright plate 541 at the upper edge. The upper flange 542 has a first notch 543 and a second notch 544 at two ends corresponding to the second hooks 534, and at least one fastening hole 545 corresponding to the fastening hole 533 of the first clamp plate 53. The cutter set 55 is fixed between the first and second clamp plates 53 and 54, and has a plurality of cutters 551 of varying lengths and is moved downwards with the first and second clamp plates 53 and 54 into the apertures 512 of the paper holding portion 51 to punch holes.

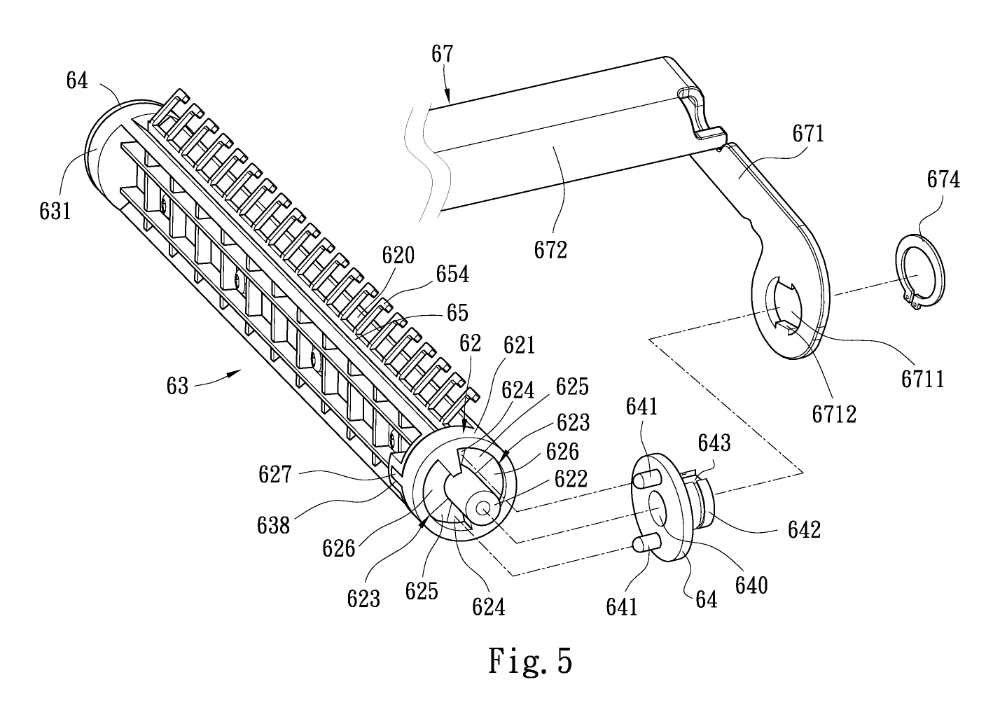

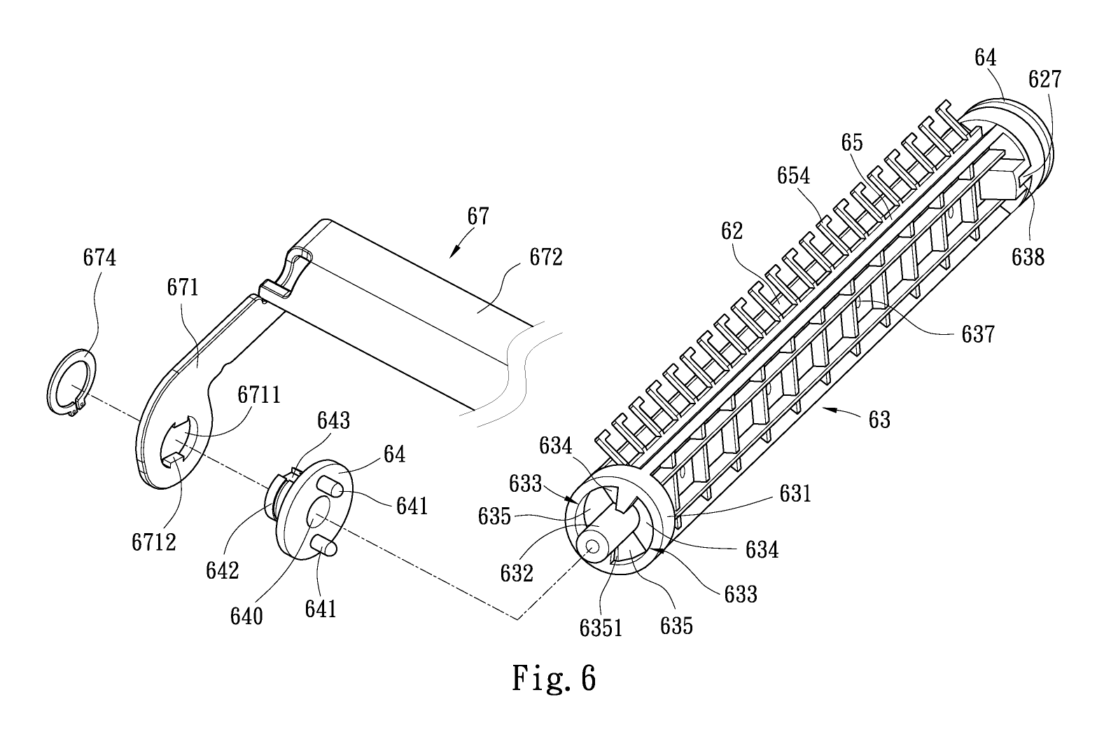

Referring to FIGS. 4, 5 and 6, the transverse moving apparatus 60 is located at the front end of the punch 50 above the base 30, and includes two corresponding axles 64 coupling with a stem 672 of the crook arm 67, a claw module 61, an aperture holding bar 66 and the crook arm 67. The axles 64 are movably coupled with two sides of the stem 672 of the crook arm 67. Each of the axles 64 has an axle cavity 640 in the center of the surface at one end and at least one strut 641 at one side near the circumference. In an embodiment two corresponding struts 641 at formed on the axles 64. Each of the axles 64 also has a stub shaft 642 at another side with a corresponding key slot 643 formed thereon.

The claw module 61 has a first adjustment bar 62 and a second adjustment bar 63 pivotally coupled on the frame 40 at the upper side, a movable bar 65 interposed between the first and second adjustment bars 62 and 63, and the aperture holding bar 66 located at a front end of the claw module 61. The first adjustment bar 62 has a first main axle 621 with a first rod 622 formed on an outer side to couple with the axle cavity 640 of the axle 64, and a first recess 623 to hold the strut 641 of the axle 64 for moving and turning therein. In this embodiment two first recesses 623 are formed corresponding to two struts 641 to transmit movements. According to a same technique, the axle 64 may also have a recess corresponding to a strut located on the claw module 61. Each first recess 623 has a first lower portion 624, a first sloped surface 625 and a first elevated plane 626 that are formed diagonally. The first main axle 621 has a first extended rod 620 and a first coupling lug 627 at another end. The first extended rod 620 has an upright surface with at least one first fastening hole 628 formed in the center and a first slot 629 formed at a distal end thereof to be wedged by a second coupling lug 636 of the second adjustment bar 63.

The second adjustment bar 63 has a second main axle 631 at another end opposite to the first main axle 621 of the first adjustment bar 62 with a second rod 632 formed on an outer side to couple with another axle cavity 640 of another axle 64, and a second recess 633 to hold the strut 641 of the axle 64 for moving and turning therein. In this embodiment two second recesses 633 are formed. Each second recess 633 has a second lower portion 634, a second sloped surface 635 and a second elevated plane 6351 that are formed diagonally. The second main axle 631 has a second extended rod 630 and the second coupling lug 636 at another end opposite to the second main axle 631. The second extended rod 630 has an upright surface with at least one second fastening hole 637 formed in the center and a second slot 638 formed at another distal end thereof to be wedged by the first coupling lug 627. The movable bar 65 has a plate 651 coupling with the first and second adjustment bars 62 and 63. The plate 651 has a plurality of inverse L-shaped claws 654 which are equally spaced from each other and fastening holes 652 corresponding to the fastening holes 628 and 637 of the first and second adjustment bars 62 and 63, and notches 653 formed at two sides wedged by the first and second coupling lugs 627 and 636. The aperture holding bar 66 is located at the front end of the claw module 61, and has an anchor seat 661 and a curved cover 663 with insertion struts 665 formed thereon in an equally spaced manner. The anchor seat 661 has two anchor members 662 at two sides fastened to the two anchor plates 42 of the frame 40 by engaging fastening elements 660 through the apertures 423 of the anchor plate 42 to anchor the aperture holding bar 66. The curved cover 663 has at least one arched slot 664 passed through by the claws 654 and jutting latch edges 666 at two lateral sides wedged in the latch notches 422 of the anchor plate 42 of the frame 40.

The crook arm 67 has two coupling portions 671 at two sides and the stem 672 connecting to one end of the coupling portions 671. The two coupling portions 671 are movably coupled with the axles 64. Each of the coupling portions 671 has a coupling hole 673 at one end adjacent to the stem 672 and a pivotal end with an axle hole 6711 formed thereon run through respectively by the first and second adjustment bars 62 and 63. The axle hole 6711 has a jutting key 6712 corresponding to the key slot 643 of the stub shaft 642 to latch thereon and secured through a clip ring on the stub shaft 642 so that the two axles 64 are movably coupled with the two coupling portions 671.

The upper cover 70 has a housing compartment inside (not shown in the drawings) coupled with the jutting edges 33 at the two lateral sides of the base 30, and a slot 71 at the upper portion of two sides passed through by each coupling portion 671 to move up and down therein. It also has a longitudinal window opening 72 run through by the aperture holding bar 66 and a longitudinal paper loading zone 73 at the bottom to receive paper loading.

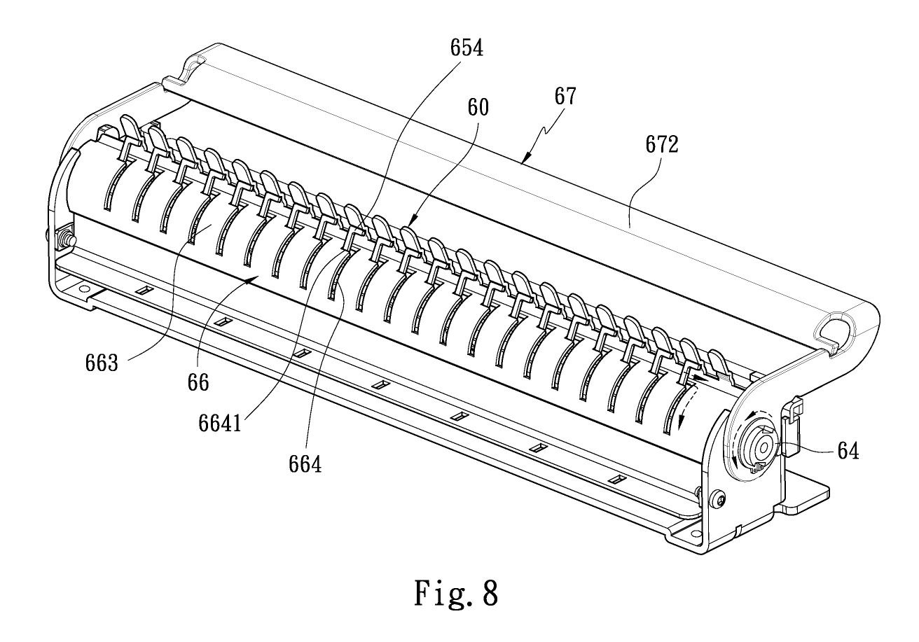

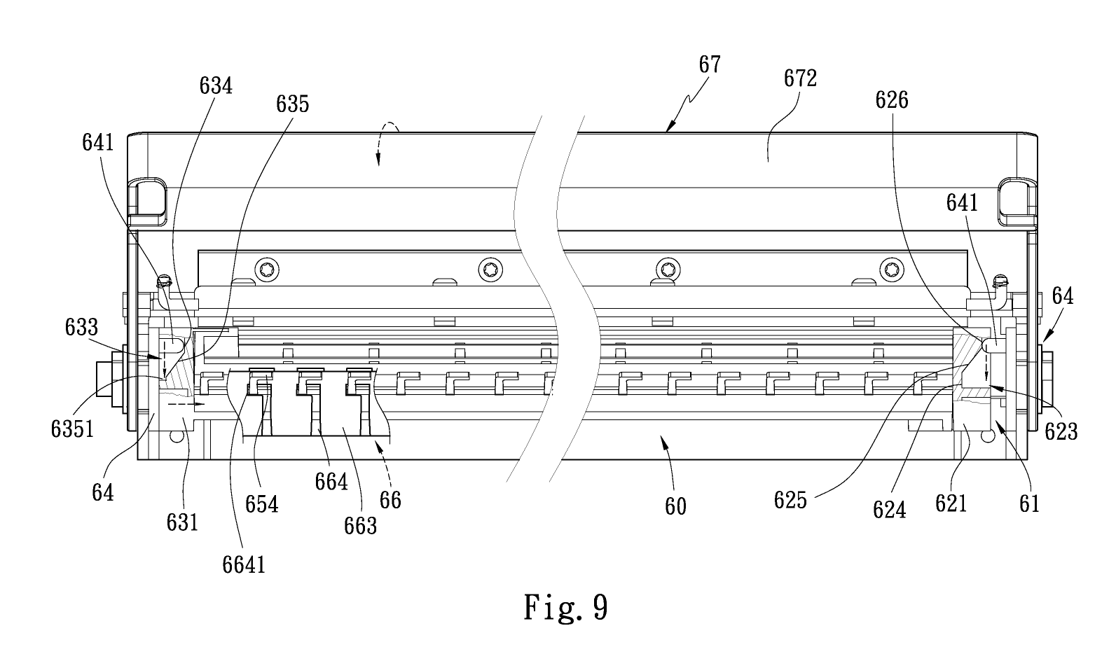

When the present invention is in use, referring to FIGS. 3 and 4, first, load the papers to be punched through the paper loading zone 73 of the upper cover 70 into the paper holding space 510 of the paper holding portion 51; push the stem 672 downwards (referring to the arrow in FIG. 7), because of the axle hole 6711 of the claw module 61 is movably coupled with the crook arm 67 by pressing the stem 672, the first and second clamp plates 53 and 54 of the cutter assembly 52 are thus moved downwards at the same time; the cutter set 55 with the cutters 551 of varying lengths also is moved downwards into the aperture 512 of the paper holding portion 51 to punch holes as desired. Referring to FIGS. 4, 8 and 9, to perform binding of the punched papers, move the stem 672 to drive the axles 64; the two struts 641 of the axles 64 move respectively in the first recess 623 and the second recess 633 from the first elevated plane 626 and second lower portion 634 towards the first and second sloped surfaces 625 and 635 to the first lower portion 624 and second elevated plane 6351 through the sloped surfaces 625 and 635, and the claws 654 passed through transverse slots 6641 of the curved cover 663 also are moved in the arched slots 664; due to the sloped surfaces 625 and 635, the claws 654 are moved axially to engage with plastic combs and unwind them in the circumferential direction to engage with the loaded and punched papers; after the papers are engaged, the claws 654 return to their original positions, and binding of the papers is finished.

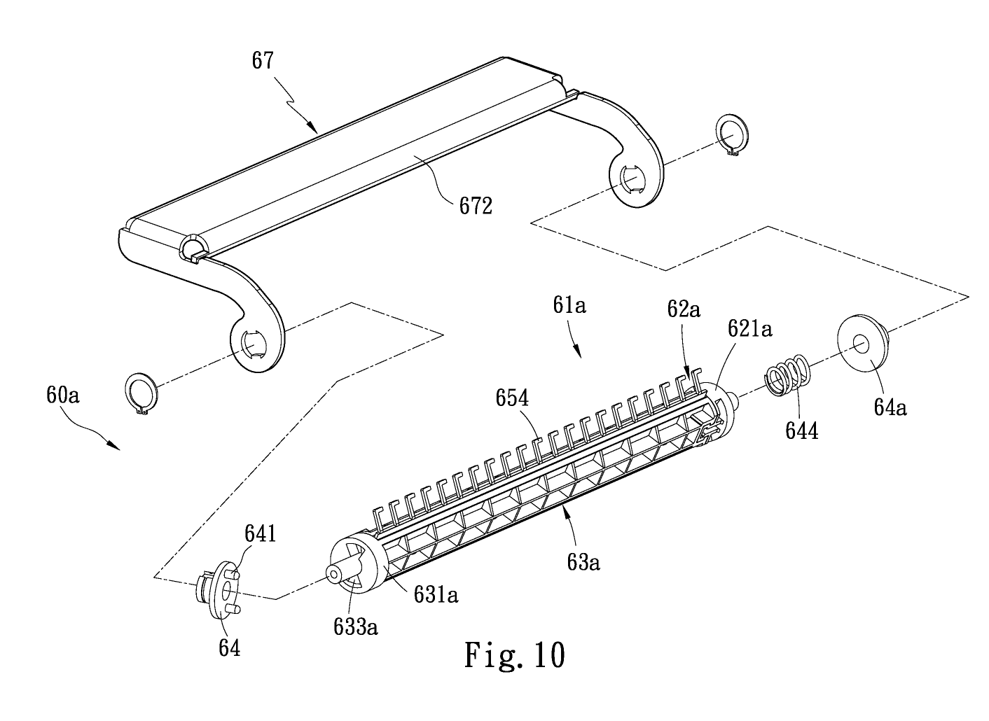

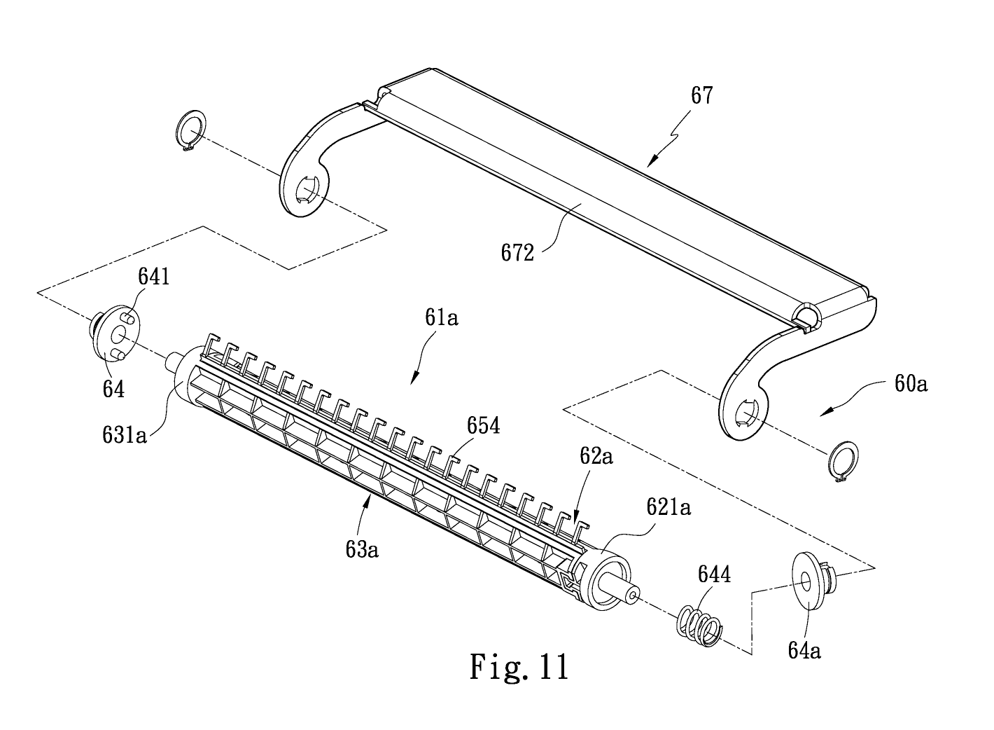

Refer to FIGS. 10 and 11 for another embodiment of the transverse moving apparatus 60a of the present invention. The stem 672 fastened to the crook arm 67 drives a first axle 64 which has two corresponding struts 641 located thereon to drive a claw module 61a through a second adjustment bar 63a with a second main axle 631a and a second recess 633a formed thereon. A second axle 64a has no strut and a first adjustment bar 62a has a first main axle 621a without a recess. The second axle 64a and the first main axle 621a are interposed by an elastic element 644. Thereby the transverse moving apparatus 60a can also be driven by the first axle 64 and the second axle 64a through the stem 672 to drive the claw module 61a through the second recess 633a with the sloped surface formed therein. Through the elastic element 644 at other side, the claws 654 can be moved axially to engage with the plastic combs and in the circumferential direction to unwind the plastic combs to bind the punched papers; then the claws 654 can return to their original positions to finish paper binding operation.

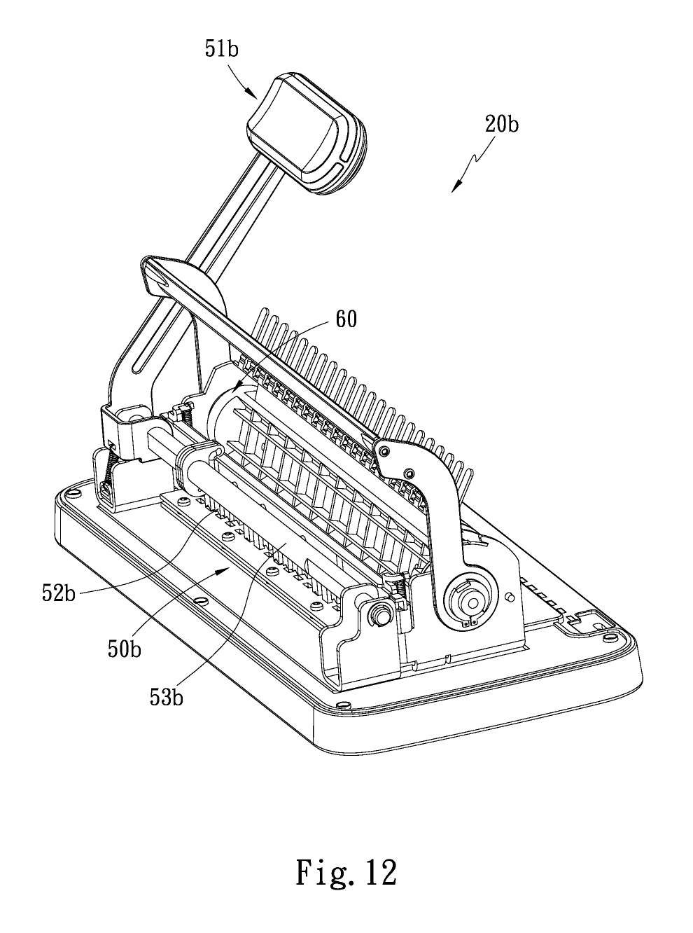

Refer to FIG. 12 for an embodiment of the transverse moving apparatus 60 to couple with another punching and binding machine 20b which has a punch 50b movable axially at a position different from binding operation. It has an external pressing bar 51b movably coupled with a shaft 53b connected to a cutter assembly 52b of the punch 50b. By pushing the pressing bar 51b downwards the cutter assembly 52b can be moved downwards through the shaft 53b to perform punch operation.

What is claimed is:

1. A transverse moving apparatus for punching and binding machines to bind papers through plastic combs, comprising:
two corresponding axles each having at least one strut at one side;
a claw module which is pivotally coupled with the two axles and has at least one recess on each of two sides to allow the strut of the axles to move and turn therein;
an aperture holding bar located at a front end of the claw module; and
a crook arm which has coupling portions at two sides and a stem bridging the two coupling portions, the coupling portions being movably coupled with the two axles.

2. The transverse moving apparatus of claim 1, wherein each of the axles has a stub shaft at another side to movably couple with each of the coupling portions and secured through a clip ring.

3. The transverse moving apparatus of claim 2, wherein the claw module has a first adjustment bar, a second adjustment bar, and a movable bar interposed between the first and second adjustment bars.

4. The transverse moving apparatus of claim 3, wherein the first adjustment bar has a first main axle which has a first rod on an outer side and a first recess to allow the strut to move and turn therein, the first recess having a first lower portion, a first sloped surface and a first elevated plane, and the second adjustment bar has a second main axle at other end opposite to the first main axle, the second main axle has a second rod on an outer side, and a second recess has a second lower portion, a second sloped surface and a second elevated plane.

5. The transverse moving apparatus of claim 4, wherein the first adjustment bar has a first extended rod and a first coupling lug located at another end opposite to the first main axle, the first extended rod having a first upright surface and at least one first fastening hole formed in the center of the first upright surface, and the first extended rod has a first distal end formed a first slot, and the second adjustment bar has a second extended rod and a second coupling lug located at another end opposite to the second main axle, the second extended rod having a second upright surface and at least one second fastening hole formed in the center of the second upright surface, and the second extended rod has a second distal end formed a second slot wedged in by the first coupling lug, and the first slot being wedged in by the second coupling lug.

6. The transverse moving apparatus of claim 3, wherein the movable bar has a plurality of claws at the top thereof and two notches at each of two sides latchable by the first and second adjustment bars.

7. The transverse moving apparatus of claim 6, wherein the claws are equally spaced from each other.

8. The transverse moving apparatus of claim 1, wherein the aperture holding bar has an anchor seat containing two anchor members located at two sides thereof and a curved cover which has insertion struts equally spaced from each other.

9. The transverse moving apparatus of claim 8, wherein the curved cover has at least one curved slot.

10. The transverse moving apparatus of claim 3, wherein the two coupling portions of the crook arm have two axle holes movably coupled with the first adjustment bar and the second adjustment bar.

11. The transverse moving apparatus of claim 1, wherein the strut of the axles butts the recess of the claw module to transmit movements.

12. A transverse moving apparatus for punching and binding machines to bind papers through plastic combs, comprising:
two corresponding axles each having at least one recess at one side;
a claw module which is pivotally coupled with the two axles and has at least one strut on each of two sides corresponding to the axles;
an aperture holding bar located at a front end of the claw module; and
a crook arm which has coupling portions at two sides and a stem bridging the two coupling portions, the coupling portions being movably coupled with the two axles.

13. A transverse moving apparatus for punching and binding machines to bind papers through plastic combs, comprising:
a first axle having two corresponding struts;
a second axle corresponding to the first axle;
a claw module which is pivotally coupled with the two axles, wherein the claw module has a first adjustment bar, a second adjustment bar, and a movable bar interposed between the first and second adjustment bars, the second adjustment bar has a second main axle at one side which has a second recess coupled with the first axle, the first adjustment bar has a first main axle at another end opposite to the second main axle, and the first main axle couples with the second axle and an elastic element interposed therebetween;
an aperture holding bar located at a front end of the claw module; and
a crook arm which has coupling portions at two sides and a stem bridging the two coupling portions, the coupling portions being movably coupled with the two axles.
